(19) United States
(12) Patent Application Publication
(10) Pub. No.: US 2024/0119684 A1
(43) Pub. Date: Apr. 11, 2024

(54) DISPLAY CONTROL APPARATUS, DISPLAY CONTROL METHOD, AND PROGRAM

(71) Applicants: Pixie Dust Technologies, Inc., Tokyo (JP); Sumitomo Pharma Co., Ltd., Osaka (JP)

(72) Inventors: Megumi TABATA, Tokyo (JP); Haruki NISHIMURA, Tokyo (JP); Akira ENDO, Tokyo (JP); Yasuhiro HABARA, Tokyo (JP); Masaki GOMI, Tokyo (JP); Yudai TAIRA, Tokyo (JP)

(73) Assignees: Pixie Dust Technologies, Inc., Tokyo (JP); Sumitomo Pharma Co., Ltd., Osaka (JP)

(21) Appl. No.: 18/545,187

(22) Filed: Dec. 19, 2023

Related U.S. Application Data
(63) Continuation of application No. PCT/JP2022/024487, filed on Jun. 20, 2022.

(30) Foreign Application Priority Data
Jun. 21, 2021 (JP) 2021-102247

(51) Int. Cl. G06T 19/00; G02B 27/01; G10L 15/26; H04R 1/32

(52) U.S. Cl. CPC G06T 19/006; G02B 27/017; G10L 15/26; H04R 1/32; G02B 2027/0178

(57) ABSTRACT

A display control apparatus for controlling display of a display device acquires speech collected by a plurality of microphones and estimates a sound-arrival direction of the acquired speech. Then, the display control apparatus causes a text image corresponding to the acquired speech to be displayed in a predetermined text display area in a display unit of the display device, and causes a symbol image associated with the text image to be displayed at a display position in the display unit, the display position corresponding to the estimated sound-arrival direction.

### CROSS-REFERENCE TO RELATED APPLICATIONS

This application is a Continuation Application of No. PCT/JP2022/24487, filed on Jun. 20, 2022, and the PCT application is based upon and claims the benefit of priority from Japanese Patent Application No. 2021-102247, filed on Jun. 21, 2021, the entire contents of which are incorporated herein by reference.

### FIELD

The present disclosure relates to a display control apparatus, a display control method, and a program.

### BACKGROUND

A hearing-impaired person may have a reduced ability to capture the arrival direction of sound due to a reduced auditory function. When such a hard-of-hearing person tries to have a conversation with a plurality of persons, it is difficult for the hard-of-hearing person to accurately recognize who is speaking what, and communication is hindered.

Japanese Patent Application Laid-Open No. 2007-334149 discloses a head-mounted display device for assisting a hearing-impaired person in recognizing ambient sound. This device allows the wearer to visually recognize the ambient sound by displaying a result of speech recognition performed on the ambient sound received by using a plurality of microphones as character information in a part of the visual field of the wearer.

To provide a display method highly convenient for a user in a display device for displaying a text image corresponding to a voice. For example, in a case where a plurality of people have a conversation in the vicinity of the user, if the user can not only recognize the content of a speech but also easily recognize who has made the speech, communication with the user becomes smoother.

### BRIEF DESCRIPTION OF THE DRAWINGS

FIG. 1 is a diagram showing a configuration example of a display device.

FIG. 2 is a diagram showing an outline of a display device.

FIG. 3 illustrates the functionality of the display device.

FIG. 4 is a flowchart showing an example of processing of a controller.

FIG. 5 is a diagram for explaining sound collection by a microphone.

FIG. 6 is a diagram for explaining an arrival direction of a sound.

FIG. 7 is a diagram showing an example of display on a display device.

FIG. 8 is a diagram showing an example of display on a display device.

FIG. 9A is a diagram showing an example of display on a display device.

FIG. 9B is a diagram showing an example of display on a display device.

FIG. 10A is a diagram showing an example of change in display of a display device.

FIG. 10B is a diagram showing an example of change in display of a display device.

FIG. 10C is a diagram showing an example of change in display of a display device.

FIG. 10D is a diagram showing an example of change in display of a display device.

FIG. 11A is a diagram showing an example of change in display of a display device.

FIG. 11B is a diagram showing an example of change in display of a display device.

FIG. 11C is a diagram showing an example of change in display of a display device.

FIG. 11D is a diagram showing an example of change in display of a display device.

FIG. 12 is a diagram showing an example of a table that associates sound sources with symbols.

### DETAILED DESCRIPTION

Hereinafter, an embodiment of the present disclosure will be described in detail with reference to the drawings. In the drawings for describing the embodiments, the same constituent elements are denoted by the same reference numerals in principle, and repeated description thereof will be omitted.

A display control apparatus according to the present disclosure has, for example, the following configuration. There is provided a display control apparatus for controlling display of a display device, the display control apparatus comprising: an acquisition unit configured to acquire speech collected by a plurality of microphones; an estimation unit configured to estimate a sound-arrival direction of the speech acquired by the acquisition unit; and a display control unit configured to display a text image corresponding to the speech acquired by the acquisition unit in a predetermined text display area of a display unit of the display device and display a symbol image associated with the text image at a display position in the display unit in accordance with the sound-arrival direction estimated by the estimation unit.

### (1) Configuration of Information Processing Apparatus

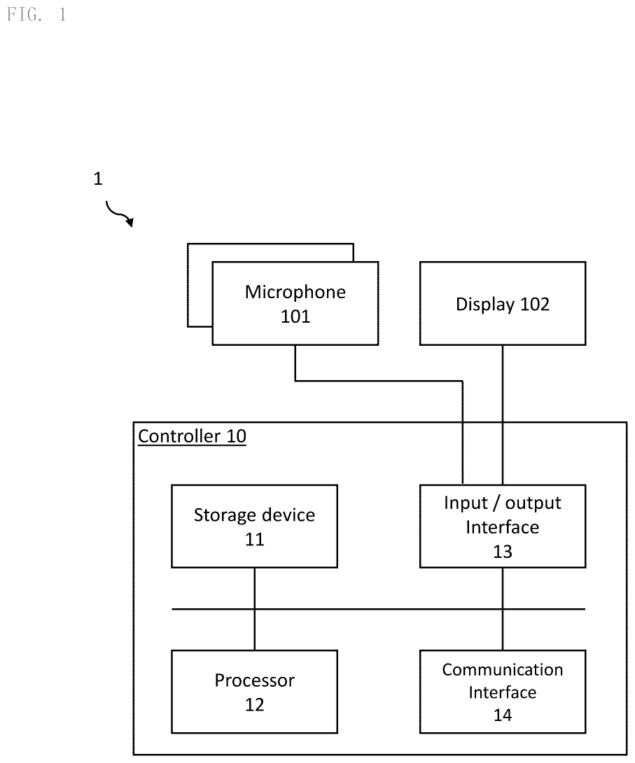

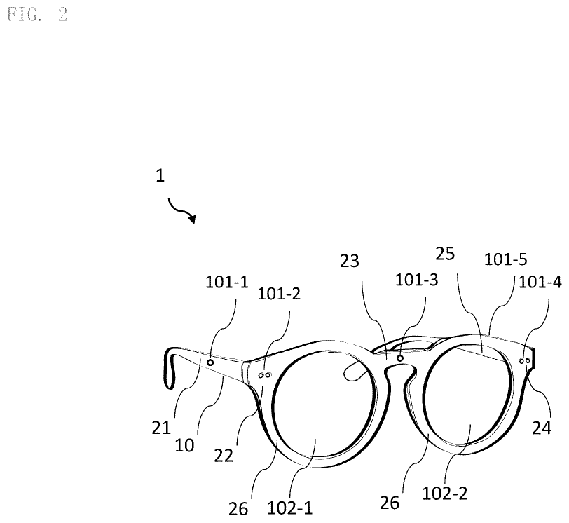

The configuration of the display device 1 of the present embodiment will be described. FIG. 1 is a diagram illustrating a configuration example of a display device according to the present embodiment. FIG. 2 is a diagram showing an outline of a glass type display device which is an example of the display device shown in FIG. 1.

The display device 1 shown in FIG. 1 is configured to acquire a sound and to display a text image corresponding to the acquired sound in such a manner that the arrival direction of the sound can be identified.

Aspects of the display device 1 include, for example, at least one of the following:
Glass type display device;
Head-mounted display;
PC; and
Tablet terminal.

As shown in FIG. 1, the display device 1 includes a plurality of microphones 101, a display 102, and a controller 10.

The microphones 101 are arranged so as to maintain a predetermined positional relationship with each other.

As shown in FIG. 2, when the display device 1 is a glass type display device, the display device 1 includes a right temple 21, a right endpiece 22, a bridge 23, a left endpiece 24, a left temple 25, and a rim 26, and can be worn by a user.

The microphone 101-1 is disposed on the right temple 21.

The microphone 101-2 is disposed on the right endpiece 22.

The microphone 101-3 is disposed in the bridge 23.

The microphone 101-4 is disposed on the left endpiece 24.

The microphone 101-5 is disposed on the left temple 25.

The number and arrangement of the microphones 101 in the display device 1 are not limited to the example of FIG. 2.

The microphone 101 collects, for example, sound around the display device 1. The sound collected by the microphone 101 includes, for example, at least one of the following sounds:
Speech sound by a person; and
Sound of an environment in which the display device 1 is used (hereinafter referred to as “environmental sound”).

When the display device 1 is a glass type display device, the display 102 is a member having transparency (for example, at least one of glass, plastic, and a half mirror). In this case, the display 102 is located within the field of view of the user wearing the glass type display device. The displays 102-1 to 102-2 are supported by the rim 26. The display 102-1 is disposed so as to be located in front of the right eye of the user when the user wears the display device 1. The display 102-2 is disposed so as to be located in front of the left eye of the user when the user wears the display device 1.

The display 102 presents (for example, displays) an image under the control of the controller 10. For example, an image is projected onto the display 102-1 from a projector (not shown) disposed on the back side of the right temple 21, and an image is projected onto the display 102-2 from a projector (not shown) disposed on the back side of the left temple 25. Thus, the display 102-1 and the display 102-2 present images. The user can visually recognize not only the image but also scenery transmitted through the display 102-1 and the display 102-2.

Note that the method by which the display device 1 presents an image is not limited to the above example. For example, the display device 1 may directly project an image from a projector to the user's eye.

The controller 10 is an information processing apparatus that controls the display device 1. The controller 10 is connected to the microphone 101 and the display 102 in a wired or wireless manner.

When the display device 1 is a glass type display device as shown in FIG. 2, the controller 10 is disposed, for example, inside the right temple 21. However, the arrangement of the controller 10 is not limited to the example of FIG. 2, and for example, the controller 10 may be configured as a separate body from the display device 1.

As shown in FIG. 1, the controller 10 includes a storage device 11, a processor 12, an input/output interface 13, and a communication interface 14.

The storage device 11 is configured to store programs and data. The storage device 11 is, for example, a combination of a read only memory (ROM), a random access memory (RAM), and a storage (for example, a flash memory or a hard disk).

The program includes, for example, the following programs:
Program of OS (Operating System); and
Program of application for executing information processing.

The data includes, for example, the following data:
Database referred to in information processing; and
Data obtained by executing information processing (that is, an execution result of the information processing).

The processor 12 is configured to realize the function of the controller 10 by running the program stored in the storage device 11. The processor 12 is an example of a computer. For example, the processor 12 activates a program stored in the storage device 11 to realize a function of presenting an image representing a text corresponding to a speech sound collected by the microphone 101 (hereinafter referred to as a “text image”) at a predetermined position on the display 102. Note that the display device 1 may include dedicated hardware such as an ASIC or an FPGA, and at least a part of the processing of the processor 12 described in the present embodiment may be executed by the dedicated hardware.

The input/output interface 13 acquires at least one of the following:
Speech signal collected by microphone 101;
A user instruction input from an input device connected to the controller 10.

The input device is, for example, a drive button, a keyboard, a pointing device, a touch panel, a remote controller, a switch, or a combination thereof.

Further, the input/output interface 13 is configured to output information to an output device connected to the controller 10. The output device is, for example, the display 102.

The communication interface 14 is configured to control communication between the display device 1 and an external device (for example, a server or a mobile terminal) which is not illustrated.

### (2) Outline of Function

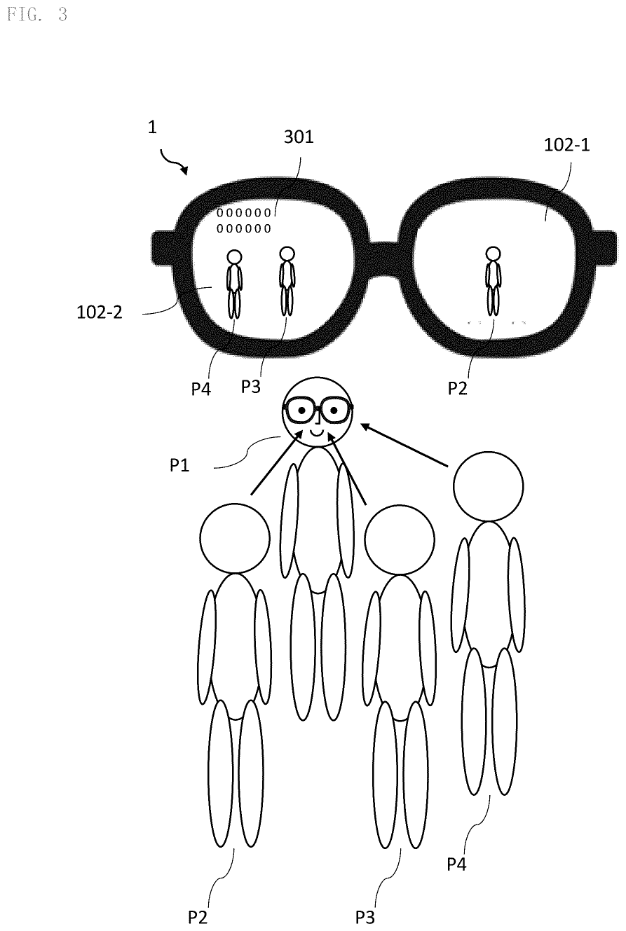

An outline of functions of the display device 1 according to the present embodiment will be described. FIG. 3 illustrates the functionality of the display device.

In FIG. 3, a wearer P1 who wears the display device 1 has a conversation with speakers P2 to P4.

The microphone 101 collects speech sounds of the speakers P2 to P4.

The controller 10 estimates a sound-arrival direction of the collected speech sound.

The controller 10 generates the text image 301 corresponding to the speech sound by analyzing the speech signal corresponding to the collected speech sound.

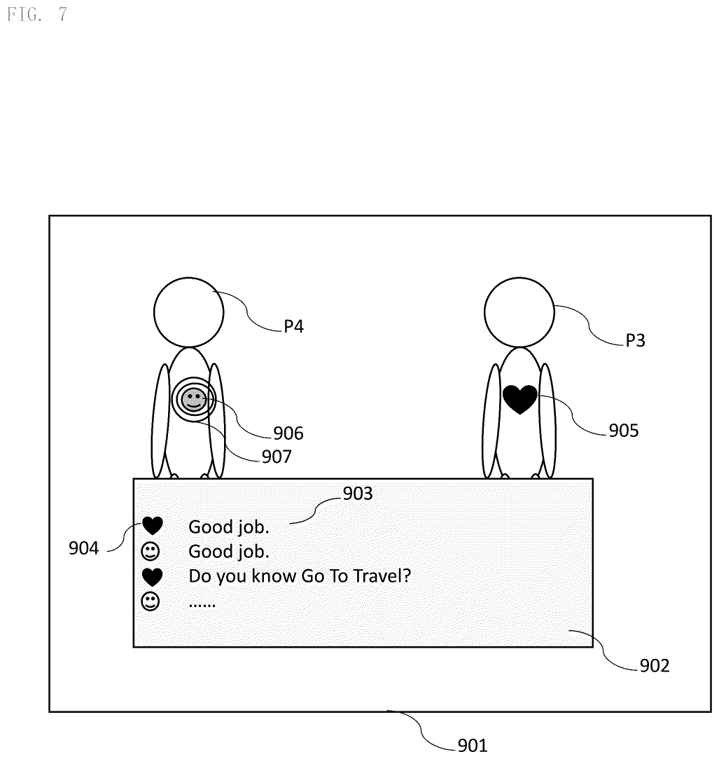

The controller 10 displays the text image 301 on the displays 102-1 to 102-2 in an aspect in which the sound-arrival direction of the speech sound corresponding to the text image can be identified. Details of the display in the aspect in which the sound-arrival direction can be identified will be described later with reference to FIGS. 7 to 9 and the like.

### (3) Processing of the Controller 10

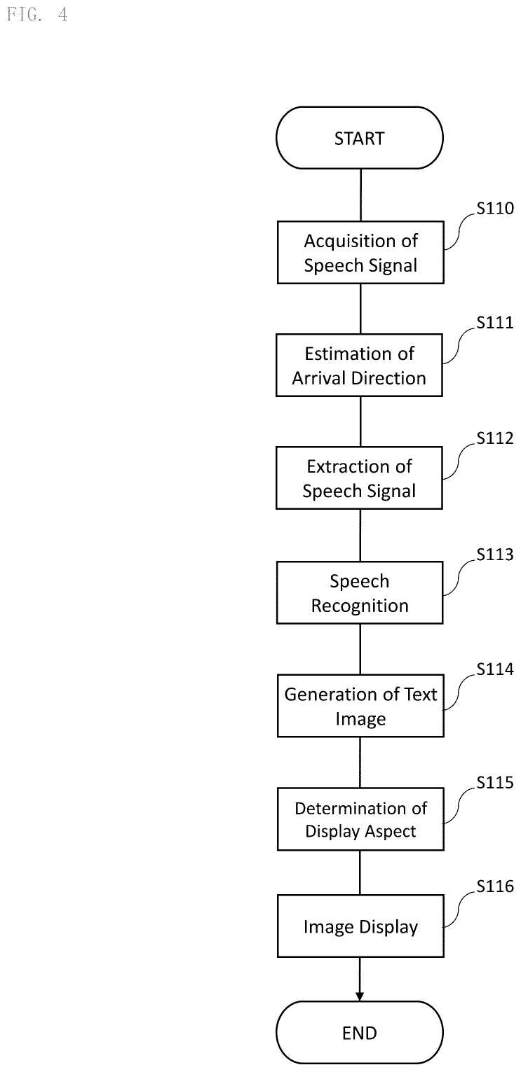

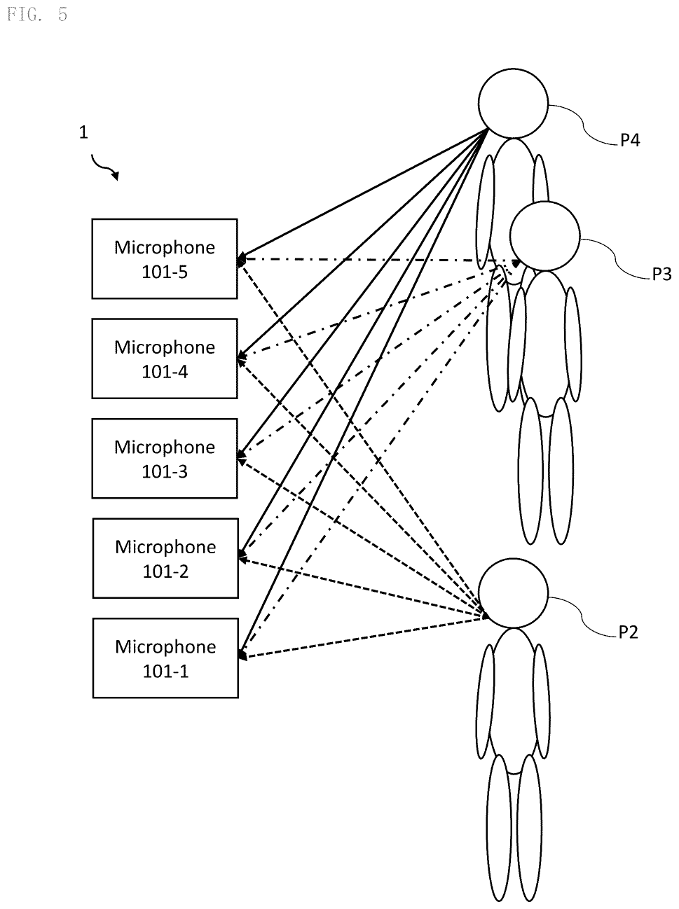

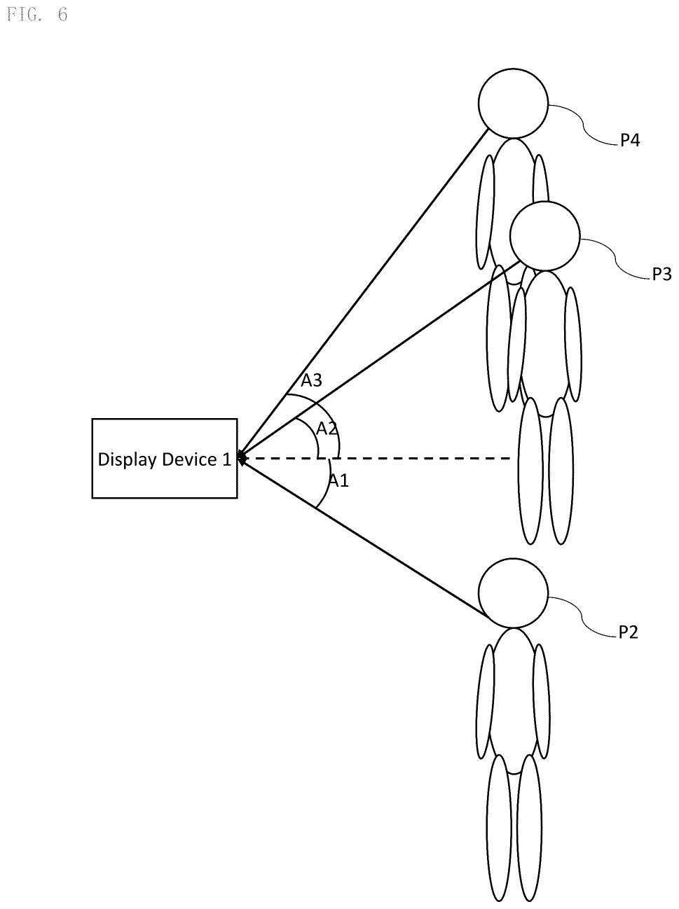

FIG. 4 is a flowchart illustrating an example of a process of the controller 10. FIG. 5 is a diagram for explaining sound collection by a microphone. FIG. 6 is a diagram for explaining the arrival direction of sound.

Each of the plurality of microphones 101 collects a speech sound emitted from a speaker. For example, in the example illustrated in FIG. 2, microphones 101-1 to 101-5 are disposed on the right temple 21, the right endpiece 22, the bridge 23, the left endpiece 24, and the left temple 25 of the display device 1, respectively. Microphones 101-1 to 101-5 collect speech sounds arriving via the paths shown in FIG. 5. The microphones 101-1 to 101-5 convert collected speech sounds into speech signals.

The processing shown in FIG. 4 is started at the timing when the power supply of the display device 1 is turned on and the initial setting is completed. However, the start timing of the processing illustrated in FIG. 4 is not limited thereto.

The controller 10 executes acquisition (S110) of the speech signal converted by the microphone 101.

To be specific, the processor 12 acquires, from the microphones 101-1 to 101-5, speech signals including speech sounds uttered from at least one of the speakers P2, P3, and P4. The speech signals acquired from the microphones 101-1 to 101-5 include spatial information (for example, frequency characteristics, delay, and the like) based on a path through which a sound wave of a speech sound has traveled.

After Step S110, the controller 10 executes estimation (S111) of the sound-arrival direction. The storage device 11 stores a sound-arrival direction estimation model. The sound-arrival direction estimation model describes information for specifying a correlation between spatial information included in a speech signal and a sound-arrival direction of a speech sound.

Any existing method may be used as the sound-arrival direction estimation method using the sound-arrival direction estimation model. For example, MUSIC (Multiple Signal Classification) using eigenvalue expansion of an input correlation matrix, a minimum norm method, ESPRIT (Estimation of Signal Parameters via Rotational Invariance Techniques), or the like is used as the sound-arrival direction estimation technique.

The processor 12 inputs the speech signals received from the microphones 101-1 to 101-5 to the sound-arrival direction estimation model stored in the storage device 11 to estimate the directions of arrival of the speech sounds collected by the microphones 101-1 to 101-5. At this time, for example, the processor 12 expresses the sound-arrival direction of the speech sound by an argument from an axis in which a reference direction (in the present embodiment, the front direction of the user wearing the display device 1) determined with reference to the microphones 101-1 to 101-5 is set to 0 degree. In the example illustrated in FIG. 6, the processor 12 estimates that the sound-arrival direction of the speech sound emitted from the speaker P2 is an angle A1 in the right direction from the axis. The processor 12 estimates that the sound-arrival direction of the speech sound emitted from the speaker P3 is an angle A2 in the left direction from the axis. The processor 12 estimates that the sound-arrival direction of the speech sound emitted from the speaker P4 is an angle A3 in the left direction from the axis.

After step S111, the controller 10 executes extraction (S112) of a speech signal.

The storage device 11 stores a beam forming model. In the beam forming model, information for specifying a correlation between a predetermined direction and a parameter for forming directivity having a beam in the direction is described. Here, the formation of directivity is a process of amplifying or attenuating sound in a specific sound-arrival direction.

The processor 12 calculates a parameter for forming directivity having a beam in the sound-arrival direction by inputting the estimated sound-arrival direction to the beam forming model stored in the storage device 11.

In the example shown in FIG. 6, the processor 12 inputs the calculated angle A1 to the beam forming model and calculates parameters for forming a directivity having a beam in the direction of the angle A1 in the right direction from the axis. The processor 12 inputs the calculated angle A2 to the beam forming model and calculates parameters for forming a directivity having a beam in the direction of the angle A2 in the left direction from the axis. The processor 12 inputs the calculated angle A3 to the beam forming model and calculates parameters for forming a directivity having a beam in the direction of the angle A3 in the left direction from the axis.

The processor 12 amplifies or attenuates the speech signals acquired from the microphones 101-1 to 101-5 with the parameter calculated for the angle A1. The processor 12 combines the amplified or attenuated speech signals to extract a speech signal of the speech sound arriving from the direction represented by the angle A1.

The processor 12 amplifies or attenuates the speech signals acquired from the microphones 101-1 to 101-5 with the parameter calculated for the angle A2. The processor 12 combines the amplified or attenuated speech signals to extract a speech signal of the speech sound arriving from the direction represented by the angle A2.

The processor 12 amplifies or attenuates the speech signals acquired from the microphones 101-1 to 101-5 with the parameter calculated for the angle A3. The processor 12 combines the amplified or attenuated speech signals to extract a speech signal of the speech sound arriving from the direction represented by the angle A3.

After Step S112, the controller 10 executes speech recognition (S113).

A speech recognition model is stored in a storage device 11. In the speech recognition model, information for specifying a correlation between a speech signal and a text corresponding to the speech signal is described. The speech recognition model is, for example, a learned model generated by machine learning.

The processor 12 inputs the extracted speech signal to the speech recognition model stored in the storage device 11 to determine a text corresponding to the input speech signal.

In the example illustrated in FIG. 6, the processor 12 inputs the speech signals extracted for the angles A1 to A3 to the speech recognition model, and thereby determines the text corresponding to the input speech signals.

After Step S113, the controller 10 executes text image generation (S114).

Specifically, the processor 12 generates a text image representing the determined text.

After step S114, the controller 10 executes determination (S115) of the display aspect.

Specifically, the processor 12 determines how to display a display image including a text image on the display 102.

After Step S115, the controller 10 executes image display (S116).

Specifically, the processor 12 displays a display image corresponding to the determined display aspect on the display 102.

### (4) Display Example of Display Device

Hereinafter, an example of a display image according to the determination of the display aspect in step S115 will be described in detail. The processor 12 causes a text image corresponding to the speech to be displayed in a predetermined text display area in the display 102 which is a display unit of the display device 1. In addition, the processor 12 displays the symbol image associated with the text image at the display position corresponding to the sound-arrival direction of the speech sound corresponding to the text image.

FIG. 7 is a diagram illustrating an example of display of a display device. The screen 901 represents the field of view that the user wearing the display device 1 is looking through the display 102. Here, the images of the speaker P3 and the speaker P4 are real images reflected in the eyes of the user through the display 102, and the window 902, the symbol 905, the symbol 906, and the mark 907 are images displayed on the display 102. It should be noted that the field of view seen through the display 102-1 and the field of view seen through the display 102-2 are actually slightly different in image position from each other, but here, in order to simplify the description, the description will be made assuming that each field of view is represented on the common screen 901.

The window 902 is displayed at a predetermined position in the screen 901. A text image 903 generated in S114 is displayed in the window 902. The text image 903 is displayed in such a manner that speeches of a plurality of speakers can be identified. For example, when the utterance of the speaker P3 is followed by the utterance of the speaker P4, the texts corresponding to the respective utterances are displayed in separate lines. When the number of lines of text displayed in the window 902 increases, the text image 903 is scrolled so that the text of the old speech is hidden and the text of the new speech is displayed.

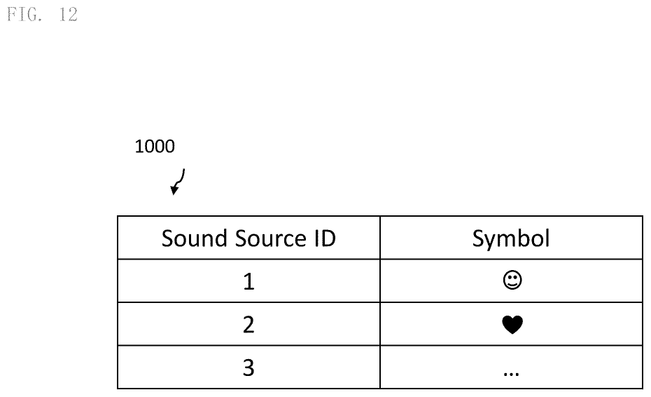

In the window 902, a symbol 904 for making it possible to identify whose speech each text included in the text image 903 represents is displayed. The sound source and the symbol type are associated with each other by a table 1000 illustrated in FIG. 12, for example. The controller 10 refers to the table 1000 stored in the storage device 11 and determines the types of symbols to be displayed in the window 902. In the example of FIG. 7, a heart-shaped symbol is displayed next to the text corresponding to the utterance of the speaker P3, and a face-shaped symbol is displayed next to the text corresponding to the utterance of the speaker P4.

Then, on the screen 901, a heart-shaped symbol 905 is displayed at a position corresponding to the sound-arrival direction of the speech uttered by the speaker P3 (in the example of FIG. 7, a position overlapping the image of the speaker P3 present in the sound-arrival direction). In addition, the face-shaped symbol 906 is displayed at a position corresponding to the sound-arrival direction of the speech uttered by the speaker P4 (in the example of FIG. 7, a position overlapping the image of the speaker P4 present in the sound-arrival direction). The types of the symbols 905 and 906 correspond to the type of the symbol 904 displayed together with the text image 903 in the window 902. That is, the symbol 904 displayed together with the text representing the utterance of the speaker P3 in the window 902 is the same type of symbol as the symbol 905 displayed at the position corresponding to the speaker P3 in the screen 901. With such a display, the user can easily identify whose speech each text included in the text image 903 in the window 902 represents. The controller 10 may determine the type of the symbol based on a result of speech recognition in the S113. For example, the controller 10 may estimate the emotion of the speaker by speech recognition in the S113 and determine the expression or the color of the symbol corresponding to the speaker based on the estimated emotion. Thus, it is possible to present information on the emotion of the speaker to the user of the display device 1.

Further, on the screen 901, a mark 907 indicating that the speaker P4 corresponding to the symbol 906 is speaking is displayed around the symbol 906. That is, the mark 907 is displayed at a position corresponding to the sound-arrival direction of the speech and indicates that the speech is emitted from the sound source located in the sound-arrival direction.

The processor 12 identifies the speeches of the plurality of speakers based on the estimation result of the sound-arrival direction of the speech. That is, when the difference between the direction of arrival of the speech corresponding to a certain utterance and the direction of arrival of the speech corresponding to another utterance is equal to or larger than a predetermined angle, the processor 12 determines that the utterances are utterances of different speakers (that is, speeches emitted from different sound sources). Then, the processor 12 causes the text image 903 to be displayed so that texts corresponding to a plurality of speeches having different sound-arrival directions can be identified, and causes the symbol 905 and the symbol 906 associated with each text to be displayed at positions corresponding to the sound-arrival directions of the speeches.

In the example of FIG. 7, the text image 903 representing the utterance of the speaker P3 and the symbol 905 indicating the sound-arrival direction of the speech uttered from the speaker P3 are associated with each other by displaying the symbol 904 of the same type as the symbol 905 in the vicinity of the text image 903. However, the method of associating the text image representing the utterance of a specific speaker with the symbol image representing the sound-arrival direction of the speech uttered from the speaker is not limited to this example. For example, in the text image 903, texts corresponding to utterances having different sound-arrival directions may be displayed in different colors. Then, a text image corresponding to a speech in a specific sound-arrival direction and a symbol image indicating the sound-arrival direction may be associated with each other by being displayed in the same color. For example, a text corresponding to the utterance of the speaker P3 may be displayed in a first color, and a symbol of the first color may be displayed at a position indicating the direction of the speaker P3. Then, the text corresponding to the utterance of the speaker P4 may be displayed in the second color, and the symbol of the second color may be displayed at the position indicating the direction of the speaker P4. The shape of the first color symbol and the shape of the second color symbol may be different from each other or may be the same.

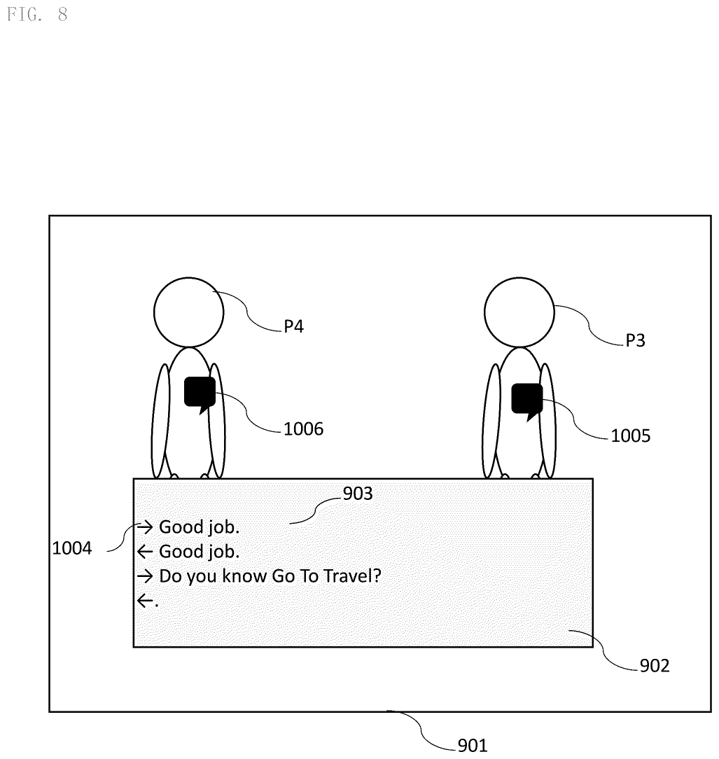

FIG. 8 is a diagram illustrating another example of display of the display device. The screen 901 includes images of the speaker P3 and the speaker P4 as in the example of FIG. 7, and the window 902 and the text image 903 are displayed. On the other hand, instead of the symbol 904, the symbol 905, and the symbol 906 in FIG. 7, a direction mark 1004, a symbol 1005, and a symbol 1006 are displayed.

Symbols 1005 and 1006 indicate the sound-arrival direction of the voice, that is, the position of the speaker. Although the symbol 1005 and the symbol 1006 are associated with speakers different from each other, they may be symbols of the same type. The direction mark 1004 indicates a direction of a sound source corresponding to each text included in the text image 903. In the example of FIG. 8, whether the sound source is positioned on the right side or the left side with respect to the front direction of the user (that is, the normal direction of the screen 901) is indicated by an arrow. To be more specific, a rightward arrow is displayed next to the text corresponding to the utterance of the speaker P3 located to the right of the user's front, and a leftward arrow is displayed next to the text corresponding to the utterance of the speaker P4 located to the left of the user's front. In this way, a symbol or a figure capable of specifying a symbol corresponding to a specific sound-arrival direction among the symbol 1005 and the symbol 1006 in the screen 901 is displayed in the vicinity of a text corresponding to a voice from the specific sound-arrival direction, so that a text image and a symbol image are associated with each other. With such a display, the user can easily identify in which direction the text included in the text image 903 in the window 902 represents the speech from the sound source located.

Note that the direction mark 1004 is not limited to two types indicating the right direction and the left direction, and may be a mark indicating more various directions. Thus, even when there are three or more speakers, it is possible to identify which text represents which speaker's utterance. Further, the direction indicated by the direction mark 1004 is not limited to the direction determined by the position of the sound source with respect to the front direction of the user, and may be determined based on the relative positions of a plurality of sound sources, for example. For example, when two speakers are located on the right side of the front of the user, a rightward arrow may be displayed adjacent to the text corresponding to the speech of the speaker located relatively on the right side, and a leftward arrow may be displayed adjacent to the text corresponding to the speech of the speaker located relatively on the left side.

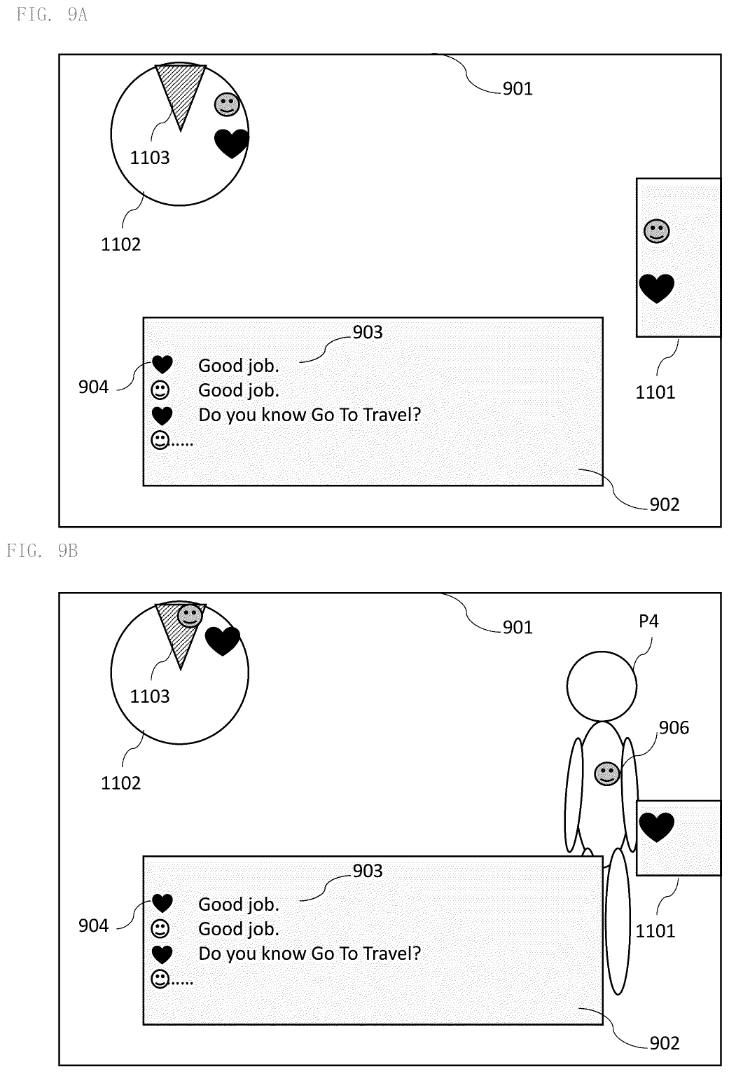

FIGS. 9A to 9D are diagrams illustrating another example of display of the display device. FIG. 9A illustrates a screen 901 in a case where the speaker P3 and the speaker P4 are present at positions deviated to the right from the field of view of the user wearing the display device 1. FIG. 9B illustrates the screen 901 in a case where the speaker P3 is present at a position deviated to the right from the field of view of the user and the speaker P4 is present within the field of view of the user. That is, when the user looking at the screen 901 of FIG. 9A turns slightly to the right, the screen 901 of FIG. 9B can be seen.

In FIG. 9A, on a screen 901, a direction indication frame 1101 indicating a direction of a sound source with respect to a field of view (FOV) of the display device 1 and a bird's-eye view map 1102 indicating a relationship between the FOV and the direction of the sound source are displayed in addition to a window 902 representing text corresponding to speech. The FOV is an angle range preset in the display device 1, and has a predetermined width in each of the elevation angle direction and the azimuth angle direction with the reference direction (the front direction of the wearer) of the display device 1 as the center. The FOV of the display device 1 is included in the field of view that the user is looking through the display device 1. In the direction indication frame 1101, an arrow indicating the direction of the sound source with respect to the FOV and a symbol identifying the sound source present in the direction indicated by the arrow are displayed. In the example of FIG. 9A, since the sound source exists in the right direction from the FOV, the direction indication frame 1101 is displayed at the right end portion of the screen 901, but when the sound source exists in the left direction from the FOV, the direction indication frame 1101 is displayed at the left end portion of the screen 901. That is, the direction indication frame 1101 is displayed at an end portion corresponding to the incoming direction of the speech among the end portions of the screen 901. In this way, the symbol image associated with the text image 903 is displayed at a position corresponding to the incoming direction of the speech. Accordingly, the user can easily recognize from which direction the speech corresponding to the text displayed in the window 902 is emitted with respect to the visual field viewed through the display device 1.

As shown in FIG. 9B, when the speaker P4 enters the FOV from the outside of the FOV, the symbol corresponding to the speaker P4 is no longer displayed in the direction indication frame 1101.

The display position of the direction indication frame 1101 is not limited to the edge of the screen 901. In addition, the content displayed in the direction indication frame 1101 is not limited to the symbol and the arrow, and at least one of them may not be included in the direction indication frame 1101, or another figure or symbol may be included in the direction indication frame 1101. When the direction indication frame 1101 includes a symbol or a figure indicating a direction such as an arrow, the direction indication frame 1101 may be displayed at a position that does not depend on the direction of the sound source.

In the bird's-eye view map 1102, an area 1103 indicating the FOV of the display device 1 and a symbol indicating the direction of the sound source are displayed. The area 1103 is displayed at a fixed position on the bird's-eye map 1102, and the symbol associated with the text image 903 is displayed at a position representing the direction of the sound source (that is, a position corresponding to the incoming direction of the speech) in the bird's-eye map 1102. By displaying such a bird's-eye map 1102, the user can easily recognize from which direction the sound corresponding to the text displayed in the window 902 is emitted with respect to the field of view seen through the display device 1. Note that the area 1103 displayed on the bird's-eye map 1102 may not exactly match the FOV of the display device 1. For example, the area 1103 may represent a range included in the visual field of the user wearing the display device 1. Further, for example, in the bird's-eye view map 1102, a reference direction of the display device 1 (a front direction of the wearer) may be indicated instead of the FOV.

As illustrated in FIG. 9B, when the speaker P4 enters the FOV, the symbol corresponding to the speaker P4 is displayed at a position overlapping the area 1103 in the bird's-eye view map 1102.

(5) Summary According to the present embodiment, the controller 10 causes the text image 903 corresponding to the speech acquired via the microphone 101 to be displayed in a predetermined text display area in the display unit of the display device 1. In addition, the controller 10 displays a symbol image associated with the text image 903 at a display position in the display unit, the display position corresponding to the estimated incoming direction of the speech. As a result, the user of the display device 1 can visually recognize the content of the conversation performed in the vicinity of the user and can easily recognize who is making each statement in the conversation.

In addition, according to the present embodiment, since the text image corresponding to the sound is collectively displayed in the predetermined text display area regardless of the position of the sound source, the user can easily follow the text image with his/her eyes. Further, even when the sound source exists outside the visual field of the user, the user can recognize the content of the speech uttered from the sound source without facing the direction of the sound source.

According to the present embodiment, the controller 10 causes the display unit to display the information indicating the relationship between the range included in the visual field of the user wearing the display device 1 and the direction of the sound source. As a result, the user can easily recognize in which direction the speaker is located when a conversation is performed outside the field of view or when the speaker is called from outside the field of view. As a result, it is possible to quickly participate in a conversation or respond to a call.

In addition, according to the present embodiment, the controller 10 causes a mark indicating that a sound is emitted from a sound source located in the sound-arrival direction to be displayed at a position which is within the display unit of the display device 1 and corresponds to the estimated sound-arrival direction of the speech. Accordingly, the user can easily identify the person who is speaking even before the text display by the speech recognition is completed.

(6) Modifications Modifications of the present embodiment will be described.

### (6.1) Modification 1

A Modification 1 of the present embodiment will be described. In Modification 1, the controller 10 limits the total number of sentences of the text image simultaneously displayed on the display 102 which is the display unit of the display device 1. Here, a sentence is a group of texts corresponding to speeches in the same sound-arrival direction collected in a single continuous sound collection period. The controller 10 displays texts corresponding to speeches having different sound-arrival directions among the speeches acquired via the microphone 101 in a distinguished manner as different sentences. In addition, the controller 10 displays the text corresponding to the speeches collected with the silent period longer than the predetermined time interposed therebetween among the speeches acquired through the microphone 101 so as to be distinguished as different sentences.

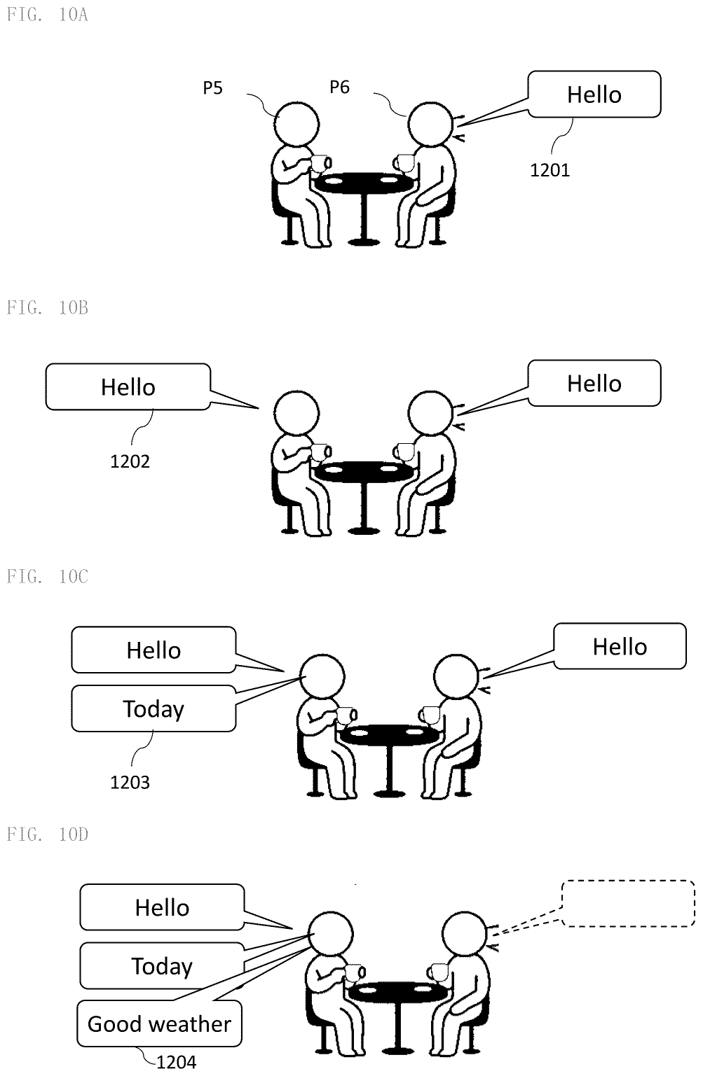

FIGS. 10A to 10D show examples of changes in the display of the display device. In this example, it is assumed that the controller 10 sets the upper limit of the total number of sentences of the text image simultaneously displayed on the display 102 to 3.

In a situation where a speaker P5 and a speaker P6 have a conversation with each other of view of the user wearing the display device 1, when the speaker P6 first speaks “Hello”, a sentence 1201 corresponding to the speech is displayed on the display 102 as shown in FIG. 10A. The total number of sentences displayed at this point is one.

Next, when the speaker P5 utters “hello”, a sentence 1202 corresponding to the utterance is displayed on the display 102 as shown in FIG. 10B. The total number of sentences displayed at this point is two.

Next, when the speaker P5 utters “today”, a sentence 1203 corresponding to the utterance is displayed on the display 102 as shown in FIG. 10C. The total number of sentences displayed at this point is three.

Next, when the speaker P5 utters “good weather”, a sentence 1204 corresponding to the utterance is displayed on the display 102 as shown in FIG. 10D. Here, since the upper limit of the total number of sentences displayed at the same time is limited to 3, the sentence 1201 corresponding to the oldest utterance among the plurality of sentences displayed on the display 102 is not displayed.

As described above, by limiting the total number of sentences of the text image simultaneously displayed on the display 102, it is possible to prevent the area in which the text image is displayed on the display 102 from becoming too large. As a result, the user wearing the display device 1 can perform smooth communication while visually recognizing both the displayed text image and the image of the real object (for example, the expression of the speaker) reflected in the eyes through the display 102.

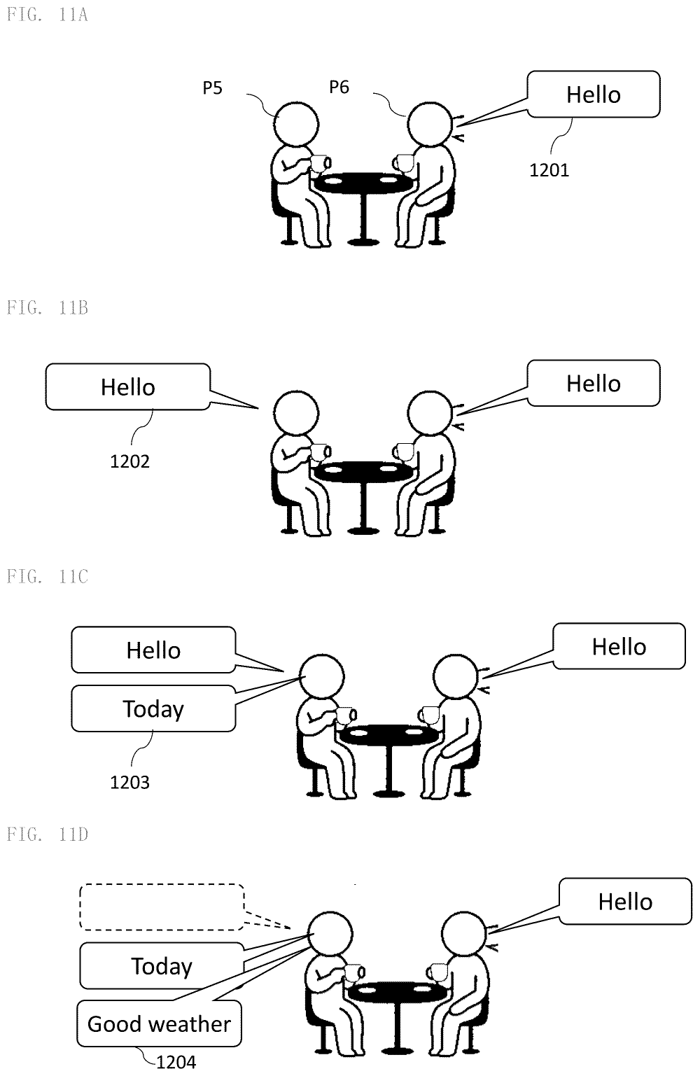

In the example illustrated in FIGS. 10A to 10D, a text image of a sentence corresponding to a speech in a certain sound-arrival direction (speech of speaker P5) and a text image of a sentence corresponding to a speech in another sound-arrival direction (speech of speaker P6) are displayed at different positions from each other so as to be identifiable. However, the display method is not limited thereto. For example, as in the above-described embodiment, a plurality of sentences corresponding to a plurality of different directions of arrival may be distinguishably displayed by displaying a text image displayed in a predetermined text display area and a symbol image associated with the text image. In FIGS. 10A to 10D and 11A to 11D, sentences are expressed by speech bubbles, but they can also be expressed by the method described with reference to FIGS. 7 to 9B.

In the example illustrated in FIGS. 10A to 10D, when the number of sentences to be displayed exceeds the upper limit, any one of the sentences is hidden. However, the present disclosure is not limited thereto, and when the number of sentences to be displayed exceeds the upper limit, the controller 10 may perform a process of making the display of any sentence less conspicuous. For example, the controller 10 may reduce at least one of the brightness, the saturation, and the contrast of the sentence that exceeds the upper limit, or reduce the size of any sentence.

The sentences displayed on the display 102 may be hidden not only when the total number of displayed sentences reaches the upper limit but also when a predetermined time elapses.

### (6.2) Modification 2

A Modification 2 of the present embodiment will be described. In Modification 2, the controller 10 limits the number of sentences of a text image simultaneously displayed on the display 102, which is the display unit of the display device 1, for each estimated sound-arrival direction.

FIGS. 11A to 11D show examples of changes in display of the display device. In this example, it is assumed that the controller 10 sets the upper limit of the number of sentences for each sound-arrival direction simultaneously displayed on the display 102 to 2.

In a situation where the speaker P5 and the speaker P6 have a conversation within the field of view of the user wearing the display device 1, when the speaker P6 first speaks “Hello”, a sentence 1201 corresponding to the speech is displayed on the display 102 as shown in FIG. 11A. At this time, the number of displayed sentences corresponding to the direction of the speaker P5 is 0, and the number of displayed sentences corresponding to the direction of the speaker P6 is 1.

Next, when the speaker P5 utters “hello”, a sentence 1202 corresponding to the utterance is displayed on the display 102 as shown in FIG. 11B. At this time, the number of displayed sentences corresponding to the direction of the speaker P5 is 1, and the number of displayed sentences corresponding to the direction of the speaker P6 is 1.

Next, when the speaker P5 utters “today”, a sentence 1203 corresponding to the utterance is displayed on the display 102 as shown in FIG. 11C. At this time, the number of displayed sentences corresponding to the direction of the speaker P5 is 2, and the number of displayed sentences corresponding to the direction of the speaker P6 is 1.

Next, when the speaker P5 utters “good weather”, a sentence 1204 corresponding to the utterance is displayed on the display 102 as shown in FIG. 11D. Here, since the upper limit of the number of sentences for each sound-arrival direction to be simultaneously displayed is limited to 2, the sentence 1202 corresponding to the oldest utterance among the plurality of sentences corresponding to the direction of the speaker P5 displayed on the display 102 is not displayed.

In this way, the number of sentences of the text image simultaneously displayed on the display 102 is limited for each sound-arrival direction. Accordingly, it is possible to prevent a situation in which only a text image corresponding to a speech of a speaker who speaks a lot of speech is displayed and a text image corresponding to a speech of a speaker who speaks a little of speech is not displayed. As a result, the user wearing the display device 1 can easily recognize the flow of conversation between a plurality of speakers.

### (6.3) Other Modifications

In the above-described embodiment, the case where the plurality of microphones 101 are integrated with the display device 1 has been mainly described. However, the present disclosure is not limited to this, and an array microphone device having a plurality of microphones 101 may be configured as a separate body from the display device 1 and connected to the display device 1 in a wired or wireless manner. In this case, the array microphone device and the display device 1 may be directly connected to each other or may be connected to each other via another device such as a PC or a cloud server.

When the array microphone apparatus and the display device 1 are configured as separate bodies, at least a part of the above-described functions of the display device 1 may be implemented in the array microphone apparatus. For example, the array microphone device may execute the estimation of the sound-arrival direction in S111 and the extraction of the speech signal in S112 in the processing flow of FIG. 4, and transmit the information indicating the estimated sound-arrival direction and the extracted speech signal to the display device 1. Then, the display device 1 may control display of an image including a text image using the received information and the speech signal.

In the above-described embodiment, the case where the display device 1 is an optical see-through glass type display device has been mainly described. However, the form of the display device 1 is not limited thereto. For example, the display device 1 may be a video see-through glass type display device. That is, the display device 1 may comprise a camera. Then, the display device 1 may cause the display 102 to display a composite image obtained by combining the above-described various display images such as the text image and the symbol image generated based on the speech recognition with the captured image captured by the camera. The captured image is an image obtained by capturing a front direction of the user, and may include an image of a speaker. In addition, for example, the controller 10 and the display 102 may be configured as separate bodies such that the controller 10 is present in a cloud server. The display device 1 may be a PC or a tablet terminal. In this case, the display device 1 may display the text image 903 and the bird's-eye view map 1102 described above on a display of the PC or the tablet terminal. In this case, the area 1103 may not be displayed on the bird's-eye view map 1102, and the upward direction of the bird's-eye view map 1102 corresponds to the reference direction of the microphone array including the plurality of microphones 101. According to such a configuration, the user can confirm the content of the conversation collected by the microphone 101 in the text image 903, and can easily recognize in which direction the speaker of each text is present with respect to the reference direction of the microphone array by the bird's-eye view map 1102.

In the embodiment described with reference to FIG. 7 and the like, the case where the predetermined text display area in which the text image 903 is displayed on the display 102 is the window 902 has been mainly described. However, the predetermined text display area is not limited to this example, and may be a region determined regardless of the direction of the display 102. The window 902 may not be displayed in the predetermined text display area. The display format of the text image in the text display area is not limited to the example shown in FIG. 7 or the like. For example, speeches from a plurality of different sound-arrival directions may be displayed in different portions in the text display area.

In the above-described embodiment, an example in which a user's instruction is input from an input device connected to the input/output interface 13 has been described, but the present disclosure is not limited thereto. The user's instruction may be input from a driving button object presented by an application of a computer (for example, a smartphone) connected to the communication interface 14.

The display 102 may be realized by any method as long as it can present an image to the user. The display 102 can be implemented by, for example, the following implementation method:
A holographic optical element (HOE) or a diffractive optical element (DOE) using an optical element (for example, a light guide plate);
Liquid crystal display;
Retinal projection display;
LED (Light Emitting Diode) display;
Organic EL (Electro Luminescence) display;
Laser display; and
A display that guides light emitted from a light emitting body using an optical element (for example, a lens, a mirror, a diffraction grating, a liquid crystal, a MEMS mirror, or an HOE).

In particular, a retinal projection display allows even a weak-sighted person to easily observe an image. Therefore, it is possible to cause a person suffering from both hearing loss and amblyopia to more easily recognize the sound-arrival direction of the speech sound.

In the speech extraction process performed by the controller 10, any method may be used as long as a speech signal corresponding to a specific speaker can be extracted. The controller 10 may extract the speech signal by, for example, the following method:
Frost beamformer;
Adaptive filter beamforming (generalized sidelobe canceller as an example); and
Speech extraction methods other than beamforming (as an example, a frequency filter or machine learning).

Although the embodiments of the present invention have been described in detail above, the scope of the present invention is not limited to the above-described embodiments. Various improvements and modifications can be made to the above-described embodiment without departing from the gist of the present invention. Further, the above-described embodiments and modifications can be combined.

According to the above disclosure, a display method can be provided which is highly convenient for a user in a display device that displays a text image corresponding to a voice.

### REFERENCE SIGNS LIST

1: display device
10: controller
101: microphone
102: display

1. A display control apparatus for controlling display of a display device, comprising:
a memory that stores codes; and
a processor that executes the codes stored in the memory to:
acquire speech collected by a plurality of microphones;
estimate a sound-arrival direction of the acquired speech;
display a text image corresponding to the acquired speech in a predetermined text display area in a display unit of the display device; and
display a symbol image associated with the text image at a display position in the display unit, the display position corresponding to the estimated sound-arrival direction.

2. The display control apparatus according to claim 1, wherein the text image and the symbol image are associated with each other by an image of a same type as the symbol image being displayed near the text image.

3. The display control apparatus according to claim 1, wherein the text image and the symbol image are associated with each other by being displayed in a same color.

4. The display control apparatus according to claim 1, wherein the text image and the symbol image are associated with each other by displaying, in a vicinity of the text image, a symbol or a graphic being capable of identifying the symbol image among a plurality of symbol images in the display unit.

5. The display control apparatus according to claim 1, wherein the display position corresponding to the sound-arrival direction is a position overlapping a sound source present in the sound-arrival direction on the display unit.

6. The display control apparatus according to claim 1, wherein the display position corresponding to the sound-arrival direction is an end portion corresponding to the sound-arrival direction among end portions of the display unit.

7. The display control apparatus according to claim 1, wherein the display position corresponding to the sound-arrival direction is a position indicating a direction of a sound source on a map indicating a relationship between a range included in a visual field of a user wearing the display device and a direction of the sound source.

8. The display control apparatus according to claim 1, wherein the processor further displays, at a position in the display unit corresponding to the estimated sound-arrival direction, a mark indicating that a sound is emitted from a sound source located in the sound-arrival direction.

9. The display control apparatus according to claim 1, wherein the text image displayed in the predetermined text display area is an image representing a text obtained by extracting a speech in a specific direction from the acquired speech and performing speech recognition.

10. The display control apparatus according to claim 1, wherein
the processor executes the codes stored in the memory to limit a total number of sentences of the text image simultaneously displayed on the display unit.

11. The display control apparatus according to claim 1, wherein
the processor executes the codes stored in the memory to limit a number of sentences of the text image simultaneously displayed on the display unit for each estimated sound-arrival direction.

12. The display control apparatus according to claim 10, wherein the sentence is a set of texts corresponding to speeches in a same sound-arrival direction collected in a single continuous sound collection period.

13. The display control apparatus according to claim 1, wherein the display device is a glass type display device that can be worn by the user.

14. A non-transitory computer-readable recording medium that stores a program which causes a computer to execute a method comprising:
acquiring speech collected by a plurality of microphones;
estimating a sound-arrival direction of the acquired speech;
causing a text image corresponding to the acquired speech to be displayed in a predetermined text display area in a display unit of the display device;
and causing a symbol image associated with the text image to be displayed at a display position in the display unit, the display position corresponding to the estimated sound-arrival direction.

15. A display control method for controlling display of a display device, comprising:
acquiring speech collected by a plurality of microphones;
estimating a sound-arrival direction of the acquired speech;
causing a text image corresponding to the acquired speech to be displayed in a predetermined text display area in a display unit of the display device;
and causing a symbol image associated with the text image to be displayed at a display position in the display unit, the display position corresponding to the estimated sound-arrival direction.

16. The display control method according to claim 15, further comprising:
limiting a total number of sentences of the text image simultaneously displayed on the display unit.

17. The display control method according to claim 15, further comprising:
limiting a number of sentences of the text image simultaneously displayed on the display unit for each estimated sound-arrival direction.
